(19) United States
(12) Patent Application Publication
(10) Pub. No.: US 2010/0128172 A1
(43) Pub. Date: May 27, 2010

(54) Apparatus and method for motion adaptive deinterlacing

(75) Inventors: Yu-Mao Lin, Tainan City (TW); Wei-Jen Lo, Hsinchu City (TW)

Correspondence Address: RABIN & Berdo, PC, 1101 14TH STREET, NW, SUITE 500, WASHINGTON, DC, 20005, US

(73) Assignee: NOVATEK MICROELECTRONICS CORP., Hsinchu (TW)

(21) Appl. No.: 12/457,527

(22) Filed: Jun. 15, 2009

(30) Foreign Application Priority Data
Nov. 24, 2008 (TW) 97145380

(51) Int. Cl. H04N 7/01

(52) U.S. Cl. 348/452; 348/E07.003

(57) ABSTRACT

An apparatus and method for motion adaptive deinterlacing is provided. The apparatus includes a motion average unit, a check area defining unit, and a combing check unit. The motion average unit is configured to obtain a weighted mean motion of a target pixel by performing weighted mean for motions of the target pixel and a plurality of neighboring pixels according to similarity of the target pixel and the neighboring pixels. The check area defining unit is configured to search for a specific check area according to the weighted mean motion. The combing check unit is configured to check combing of the specific check area for a deinterlacing format determining unit to determine a deinterlacing method for the pixels within the specific check area.

This application claims the benefit of Taiwan application Serial No. 97145380, filed Nov. 24, 2008, the subject matter of which is incorporated herein by reference.

### BACKGROUND OF THE INVENTION

1. Field of the Invention

The invention relates in general to an apparatus and method for motion adaptive deinterlacing, and particularly to an apparatus and method for motion adaptive deinterlacing to reduce text glittering.

2. Description of the Related Art

Nowadays, deinterlacing is a common feature for devices such as televisions, Digital Video Disk (DVD) players, and set-top boxes (STB). Deinterlacing is a technique to transform an interlacing signal to a progressive signal; for example, interlacing contents of a standard display (i.e. SD 480i) or a high-definition display (i.e. HD 1080i) would be transformed to a progressive standard display (i.e. SD 480p) or a progressive high-definition display (i.e. HD 1080p) for suitable use on the newly continuous scanning displays, such as liquid crystal displays (LCDs) or plasma displays.

Traditional deinterlacing devices perform motion detection to the input fields, and use the “BOB” method or the “WEAVE” method to deinterlace video contents according to the motion detected. However, in the traditional single process of motion average calculation, a moving object would lead to overvalued motion for the neighboring static pixels. Thus, deinterlacing of the static pixels would erroneously apply the “BOB” method instead of the “WEAVE” method, which leads to blurring around the moving object. Specifically, such problems commonly occur to texts with a moving neighboring area or background. A traditional display with the erroneously interlacing method is shown with reference to the Exhibit 1. In the Exhibit 1, deinterlacing of the texts would apply the “BOB” method because of the moving objects around the texts, thus leads to unstable text glittering.

### SUMMARY

The invention is directed to an apparatus and method for motion adaptive deinterlacing, which is configured to obtain a weighted mean motion according to similarity of a target pixel and its neighboring pixels, thus reducing blurring around the moving object and text glittering.

According to a first aspect of the present invention, an apparatus for motion adaptive deinterlacing is provided, which comprises a motion average unit, a check area defining unit, and a combing check unit. The motion average unit is configured to obtain a weighted mean motion of a target pixel by performing weighted mean for motions of the target pixel and a plurality of neighboring pixels according to similarity of the target pixel and the neighboring pixels. The check area defining unit is configured to search for a specific check area according to the weighted mean motion. The combing check unit is configured to check combing of the specific check area for a deinterlacing format determining unit to determine a deinterlacing method for pixels within the specific check area.

According to a second aspect of the present invention, a method for motion adaptive deinterlacing is provided, which comprises: comparing the intensity of the target pixel and the neighboring pixels to determine the similarity of the target pixel and the neighboring pixels; determining weights of the target pixel and the neighboring pixels for performing the weighted mean according to the similarity of the target pixel and the neighboring pixels; and obtaining the weighted mean motion of the target pixel by performing the weighted mean for the motions of the target pixel and the neighboring pixels according to the weights of the target pixel and the neighboring pixels.

The invention will become apparent from the following detailed description of the preferred but non-limiting embodiments. The following description is made with reference to the accompanying drawings.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 shows a block diagram of an apparatus for motion adaptive deinterlacing according to an embodiment of the invention;

FIG. 2 shows a block diagram of a motion average unit according to an embodiment of the invention;

FIG. 3 shows an illustration of a plurality of pixels according to an embodiment of the invention;

FIG. 4 shows a schematic diagram of the relationship between weight and similarity according to an embodiment of the invention; and

FIG. 5 shows a flowchart of a method for motion adaptive deinterlacing according to an embodiment of the invention.

Exhibit 1 shows a traditional display with the erroneously interlacing method;

### DESCRIPTION OF THE EMBODIMENTS

The invention provides an apparatus and method for motion adaptive deinterlacing, which performs weighted mean for motions of the pixels to obtain a weighted mean motion for a target pixel according to a similarity of the target pixel and its neighboring pixels, thus reducing text glittering problems.

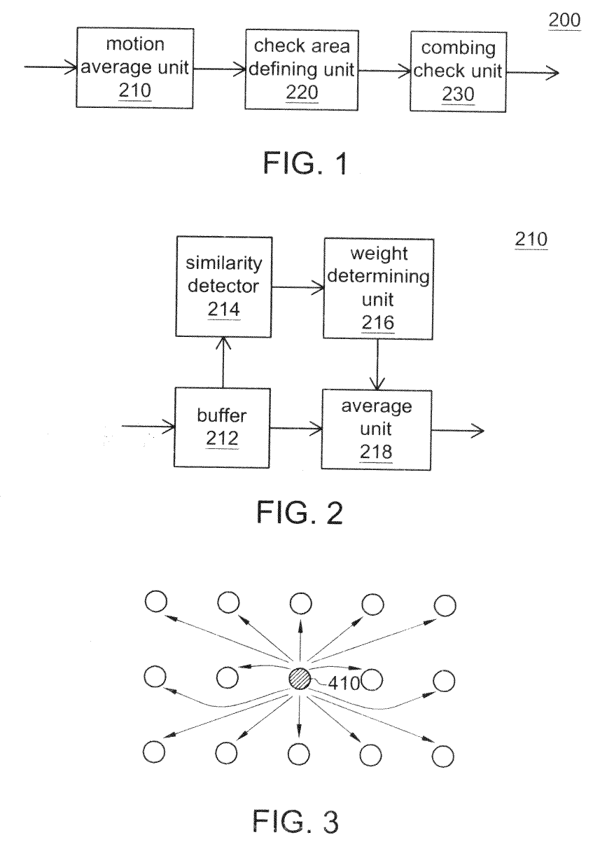

Referring to FIG. 1, a block diagram of an apparatus for motion adaptive deinterlacing according to an embodiment of the invention is shown. The apparatus for motion adaptive deinterlacing 200 includes a motion average unit 210, a check area defining unit 220, and a combing check unit 230. In this embodiment, data of pixels received by the apparatus for motion adaptive deinterlacing 200 is in the form of serial data transmission.

The motion average unit 210 obtains a weighted mean motion of a target pixel by performing weighted mean for motions of the target pixel and a plurality of neighboring pixels according to similarity of the target pixel and the neighboring pixels. Referring to FIG. 2, a block diagram of a motion average unit according to an embodiment of the invention is shown. The motion average unit 210 includes a buffer 212, a similarity detector 214, a weight determining unit 216 and an average unit 218. The motion average unit 210 receives data of pixels in serial forms, which includes intensity and motion of each of the pixels, and stores the data of these pixels in the buffer 212.

The similarity detector 214 compares the intensity of the target pixel and the neighboring pixels to determine the similarity of the target pixel and the neighboring pixels. Referring to FIG. 3, an illustration of a plurality of pixels according to an embodiment of the invention is shown. In FIG. 3, the intensity of each of the neighboring pixels is compared to the intensity of the target pixel 410. If difference of the intensity between the target pixel and the neighboring pixels decreases, the similarity of the target pixel and the neighboring pixels increases, which means the correspondence is higher. On the contrary, if difference of the intensity between the target pixel and the neighboring pixels increases, the similarity of the target pixel and the neighboring pixels decreases, which means the correspondence is lower.

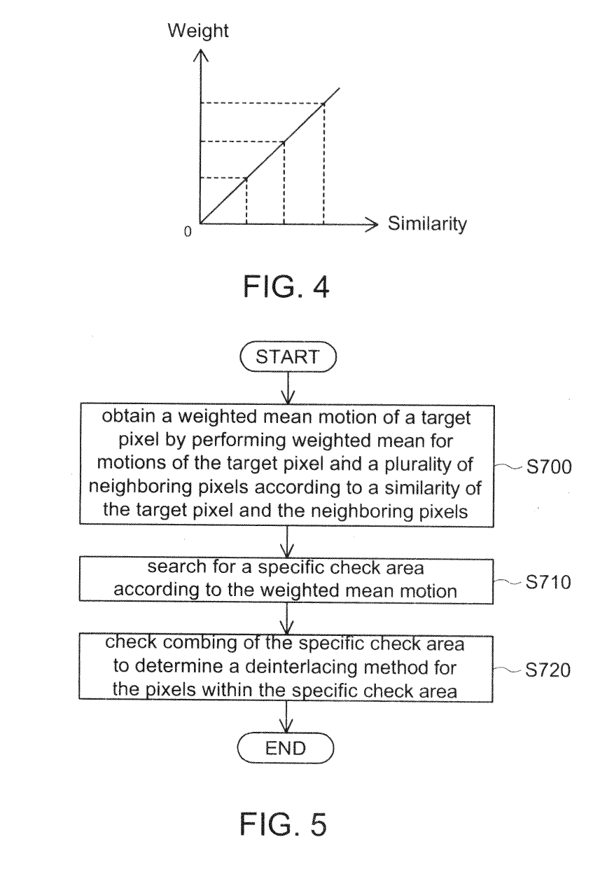

The weight determining unit 216 determines weights of the target pixel and the neighboring pixels for performing the weighted mean according to the similarity of the target pixel and the neighboring pixels. Referring to FIG. 4, a schematic diagram of the relationship between weight and similarity according to an embodiment of the invention is shown. As shown in FIG. 4, when the similarity of the target pixel and the neighboring pixels increases, the weights of the neighboring pixels increases, but each of the weights of the neighboring pixels is no larger than the weight of the target pixel. On the contrary, when the similarity of the target pixel and the neighboring pixels decreases, the weights of the neighboring pixels decreases. Furthermore, if difference of the intensity between the target pixel and the neighboring pixels is too large, the similarity is so small that the weights of the neighboring pixels would be defined as zero (0).

The average unit 218 performs the weighted mean for the motions of the target pixel and the neighboring pixels according to the weights of the target pixel and the neighboring pixels determined by the weight determining unit 216, thus obtaining the weighted mean motion of the target pixel. In this way, pixels with different motions would have different weights, so the moving object would not lead to overvalued motions for the neighboring static pixels, thus effectively reducing blurring around the moving object.

When the average unit 218 obtains the weighted mean motion of the target pixel, the check area defining unit 220 searches for a specific check area according to the weighted mean motion. If the weighted mean motion is larger than a threshold value, the check area defining unit 220 determines the target pixel is positioned within a moving area; thus, the check area defining unit 220 sets the target pixel as a center and extends toward both sides for a certain area, such as twenty (20) pixels, to obtain the specific check area.

The combing check unit 230 checks combing of the specific check area, and sends the checking result to a deinterlacing format determining unit (not shown in the figures). Thus, the deinterlacing format determining unit determines a deinterlacing method for pixels within the specific check area according to the checking result. Specifically, the pixels having combing within the specific check area are deinterlaced by the “BOB” method, and the pixels without combing can be deinterlaced by other methods such as the “WEAVE” method or a combined method.

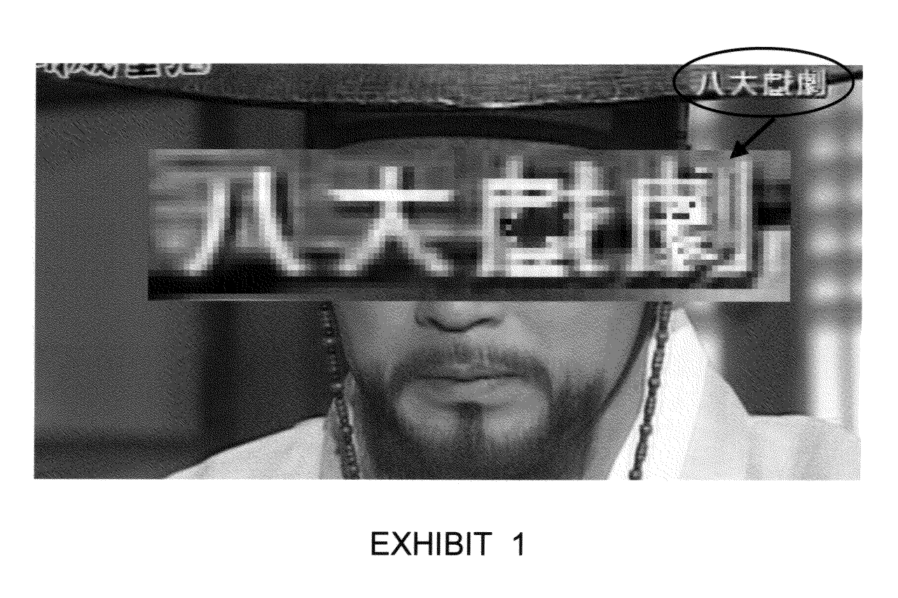

The invention also provides a method for motion adaptive deinterlacing. Referring to FIG. 5, a flowchart of a method for motion adaptive deinterlacing according to an embodiment of the invention is shown. In the step S700, a weighted mean motion of a target pixel is obtained by performing weighted mean for motions of the target pixel and a plurality of neighboring pixels according to a similarity of the target pixel and the neighboring pixels. In the step S710, a specific check area is searched for according to the weighted mean motion. In the step S720, combing of the specific check area is checked to determine a deinterlacing method for the pixels within the specific check area.

Operations and performances of the method for motion adaptive deinterlacing of the embodiment of the invention have been described in detail in the above-mentioned descriptions of the apparatus for motion adaptive deinterlacing 200, and are not hereinafter described again.

According to the embodiments of the invention, the apparatus and method for motion adaptive deinterlacing compares the intensity of the target pixel and the neighboring pixels to determine the similarity of the target pixel and the neighboring pixels, thus determining various weights of the neighboring pixels in order to perform the weighted mean for the motions to obtain the weighted mean motion of the target pixel. Thus, the moving object would not lead to overvalued motions for the neighboring static pixels, thus effectively reducing text glittering.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. An apparatus for motion adaptive deinterlacing, comprising:
a motion average unit for obtaining a weighted mean motion of a target pixel by performing weighted mean for motions of the target pixel and a plurality of neighboring pixels according to a similarity of the target pixel and the neighboring pixels;
a check area defining unit for searching for a specific check area according to the weighted mean motion; and
a combing check unit for checking combing of the specific check area for a deinterlacing format determining unit to determine a deinterlacing method for the pixels within the specific check area.

2. The apparatus for motion adaptive deinterlacing according to claim 1, wherein the motion average unit comprises:
a buffer for storing intensity and motions of the pixels;
a similarity detector for determining the similarity of the target pixel and the neighboring pixels by comparing the intensity of the target pixel and the neighboring pixels;
a weight determining unit for determining weights of the target pixel and the neighboring pixels for performing the weighted mean according to the similarity of the target pixel and the neighboring pixels; and
a average unit for obtaining the weighted mean motion of the target pixel by performing the weighted mean for the motions of the target pixel and the neighboring pixels according to the weights of the target pixel and the neighboring pixels.

3. The apparatus for motion adaptive deinterlacing according to claim 2, wherein the similarity of the target pixel and the neighboring pixels increases when difference of the intensity between the target pixel and the neighboring pixels decreases.

4. The apparatus for motion adaptive deinterlacing according to claim 3, wherein the weights of the neighboring pixels increases when the similarity of the target pixel and the neighboring pixels increases, but each of the weights of the neighboring pixels is no larger than the weight of the target pixel.

5. The apparatus for motion adaptive deinterlacing according to claim 1, wherein, if the weighted mean motion is larger than a threshold value, the check area defining unit sets the target pixel as a center and extends to obtain the specific check area.

6. The apparatus for motion adaptive deinterlacing according to claim 1, wherein the pixels having combing within the specific check area are deinterlaced by a “BOB” method.

7. A method for motion adaptive deinterlacing, comprising:
obtaining a weighted mean motion of a target pixel by performing weighted mean for motions of the target pixel and a plurality of neighboring pixels according to a similarity of the target pixel and the neighboring pixels;
searching for a specific check area according to the weighted mean motion; and
checking combing of the specific check area to determine a deinterlacing method for the pixels within the specific check area.

8. The method for motion adaptive deinterlacing according to claim 7, further comprising:
buffering intensity and motions of the pixels;
comparing the intensity of the target pixel and the neighboring pixels to determine the similarity of the target pixel and the neighboring pixels;
determining weights of the target pixel and the neighboring pixels for performing the weighted mean according to the similarity of the target pixel and the neighboring pixels; and
obtaining the weighted mean motion of the target pixel by performing the weighted mean for the motions of the target pixel and the neighboring pixels according to the weights of the target pixel and the neighboring pixels.

9. The method for motion adaptive deinterlacing according to claim 8, wherein the similarity of the target pixel and the neighboring pixels increases when difference of the intensity between the target pixel and the neighboring pixels decreases.

10. The method for motion adaptive deinterlacing according to claim 9, wherein the weights of the neighboring pixels increases when the similarity of the target pixel and the neighboring pixels increases, but each of the weights of the neighboring pixels is no larger than the weight of the target pixel.

11. The method for motion adaptive deinterlacing according to claim 7, wherein, if the weighted mean motion is larger than a threshold value, the check area defining unit sets the target pixel as a center and extends to obtain the specific check area.

12. The method for motion adaptive deinterlacing according to claim 7, further comprising deinterlacing the pixels having combing within the specific check area by a “BOB” method.
